(19) United States
(12) Patent Application Publication
(10) Pub. No.: US 2016/0092164 A1
(43) Pub. Date: Mar. 31, 2016

(54) MACHINE INSTRUCTIONS FOR CONVERTING TO DECIMAL FLOATING POINT FORMAT FROM PACKED DECIMAL FORMAT

(71) Applicant: International Business Machines Corporation, Armonk, NY (US)

(72) Inventors: Jonathan D. Bradbury, Poughkeepsie, NY (US); Steven R. Carlough, Poughkeepsie, NY (US); Reid T. Copeland, Markham (CA); Marcel Mitran, Markham (CA)

(21) Appl. No.: 14/810,754

(22) Filed: Jul. 28, 2015

Related U.S. Application Data
(63) Continuation of application No. 14/502,030, filed on Sep. 30, 2014.

(51) Int. Cl. G06F 5/00

(52) U.S. Cl. CPC G06F 5/00; G06F 2205/003

(57) ABSTRACT

Embodiments relate to converting data from a packed decimal format to a decimal floating point format by executing a machine instruction. A method of executing the machine instruction is provided. The method reads data in a packed decimal format from a memory that is communicatively coupled to a processor. The method converts the data in the packed decimal format into a decimal floating point format. The method writes the data converted into the decimal floating point format to one or more target registers of the processor.

### DOMESTIC PRIORITY

This application is a continuation of U.S. patent application Ser. No. 14/502,030, filed Sep. 30, 2014, the disclosure of which is incorporated by reference herein in its entirety.

### CROSS-REFERENCE TO RELATED APPLICATION

This application is related to U.S. patent application, with Attorney Docket No. POU920140126US1, entitled “MACHINE INSTRUCTIONS FOR CONVERTING FROM DECIMAL FLOATING POINT FORMAT TO PACKED DECIMAL FORMAT”, concurrently filed, which is incorporated herein by reference in its entirety.

### BACKGROUND

The present invention relates generally to converting data from one format to another format, and more specifically, to converting data between the packed decimal format and the decimal floating point format by executing a machine instruction.

Conventionally, operations used to process numerical decimal (i.e., base 10) data stored in the packed decimal format in a database operate directly on storage. These operations are referred to as storage-to-storage decimal operations. The performance of the storage-to-storage operations are limited by the latency of the memory interface because each operation that is dependent on the results from a prior operation must wait until the results are written out to memory before it may begin. As the gap between memory latency and processor speed continues to increase, the relative performance of these operations continues to decrease.

### SUMMARY

Embodiments include a computer program product, a method, and a system for executing a machine instruction. According to an embodiment of the present invention, a method of converting data from one format to another format by executing a machine instruction is provided. The method reads data in a packed decimal format from a memory that is communicatively coupled to a processor. The method converts the data in the packed decimal format into a decimal floating point format. The method writes the data converted into the decimal floating point format to one or more target registers of the processor.

According to another embodiment of the present invention, a computer program product for converting data from one format to another format is provided. The computer program product comprises a computer readable storage medium having machine instructions embodied therewith. The machine instructions readable by a processor cause the processing circuit to perform a method. The method reads data in a packed decimal format from a memory that is communicatively coupled to the processor. The method converts the data in the packed decimal format into a decimal floating point format. The method writes the data converted into the decimal floating point format to one or more target registers of the processor.

According to a further embodiment of the present invention, a computer system for converting data in one format to another format is provided. The computer system comprises a memory having data in a packed decimal format. The computer system further comprises a processor configured to execute a machine instruction to perform a method. The method reads data in a packed decimal format from the memory, which is communicatively coupled to the processor. The method converts the data in the packed decimal format into a decimal floating point format. The method writes the data converted into the decimal floating point format to one or more target registers of the processor.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a block diagram of a computer system according to an embodiment of the invention;

FIG. 2 depicts a format of a machine instruction according to an embodiment of the invention;

FIG. 3 depicts a process flow for converting data according to an embodiment of the invention;

FIG. 4 depicts a format of a machine instruction according to an embodiment of the invention; and

FIG. 5 depicts a process flow for converting data according to an embodiment of the invention.

### DETAILED DESCRIPTION

An IEEE Standard (IEEE 754-2008) for floating point numbers includes a standard for decimal floating point operations and number formats. This standard has been supported by conventional computing systems. However, in these conventional computing systems, the floating point operations do not interact with data in the packed decimal format very well. This is because software routines for handling data in the packed decimal format have to be manually developed and therefore are not readily available for these systems, and also because there has not been an efficient way to convert data from the packed decimal format to a decimal floating point format.

The embodiments of the invention efficiently convert data between the packed decimal format and a decimal floating point format without the memory overhead associated with the storage-to-storage operations. Specifically, the embodiments of the invention provide two exemplary machine instructions for converting data from the packed decimal format to the decimal floating point format. These two exemplary instructions are referred to herein as a long Convert from Packed instruction (CDPT) and an extended Convert from Packed instruction (CXPT). CDPT is for reading data (e.g., up to 16 digits) in the packed decimal format from a memory, converting the data into an appropriate decimal floating point format with a zero exponent and writing the data in the decimal floating point format to a target floating point register. CXPT is for reading data (e.g., up to 34 digits) in the packed decimal format from a memory, converting the data into an appropriate decimal floating point format with a zero exponent and writing the data in the decimal floating point format to a target floating point register pair.

The embodiments of the invention further provide two other exemplary machine instructions for instructions for converting data from the decimal floating point format to the packed decimal format. These two exemplary instructions are referred to herein as a long Convert to Packed instruction (CPDT) and an extended Convert to Packed instruction (CPXT). CPDT is for reading data in a decimal floating point format from a specified floating point register, converting the mantissa of the data in the specified floating point register to the packed decimal format and writing the data to a target memory location. CPXT is for converting extended precision decimal floating point data in a floating point register pair to the packed decimal format and storing the data to a target memory location.

As known in the art, in the packed decimal format, a number is represented in a series of 8-bit bytes, where four bits of every byte are allocated to a single decimal digit, allowing each byte to represent two decimal digits. One of the 4-bit patterns is allocated to a sign (positive or negative). The packed decimal number can be of any specified length, up to a limit imposed by the applicable language, with an implicit decimal point assumed at some fixed location.

As known in the art, a decimal floating point format is intended for different uses than the packed decimal format. The decimal digits are encoded using a different, more compact representation in a decimal floating point format. Decimal floating point data may be represented in any of three data formats: short, long, or extended. The contents of each of the three data formats represent encoded information. Special codes are assigned to distinguish finite numbers from NaNs (Not-a-Number) and infinites. For finite numbers, a biased exponent is used in the format. For each of the three formats, a different bias is used for right-units-view exponents from that for left-units-view exponents. The biased exponents are unsigned numbers. The biased exponent is encoded with the leftmost digit of the significand in the combination field. The remaining digits of the significand are encoded in the encoded trailing-significand field.

When an operand (i.e., data) in the decimal floating point short format is loaded into a floating-point register, the operand occupies the left half of the register, and the right half remains unchanged. When an operand in the decimal floating point double precision format (i.e., the decimal floating point long format) is loaded into a floating-point register, the operand occupies the entire register. An operand in the decimal floating point extended format occupies a floating point register pair. The leftmost 64 bits occupy the entire lower-numbered register of the pair and the rightmost 64 bits occupy the entire higher-numbered register. The sign bit is in bit 0 of each format, and is, for instance, zero for plus and one for minus.

For finite numbers, the combination field includes the biased exponent and the leftmost digit of the significand; for NaNs and infinities, the combination field includes codes to identify the NaNs and infinities. When bits 1-5 of the format are in the range of 00000-11101, the operand is a finite number. The two leftmost bits of the biased exponent and the leftmost digit of the significand are encoded in bits 1-5 of the format. Bit 6 through the end of the combination field include the rest of the biased exponent. When bits 1-5 of the format field are 11110, the operand is an infinity. All bits in the combination field to the right of bit 5 of the format constitute the reserved field for infinity. A nonzero value in the reserved field is accepted in a source infinity; the reserved field is set to zero in a resultant infinity. When bits 1-5 of the format are 11111, the operand is a NaN and bit 6, called the SNaN bit, further distinguishes QNaN (quiet NaN) from SNaN (signaling NaN). If bit 6 is zero, then it is QNaN; otherwise, it is SNaN. All bits in the combination field to the right of bit 6 of the format constitute the reserved field for NaN. A nonzero value in the reserved field is accepted in a source NaN; the reserved field is set to zero in a resultant NaN.

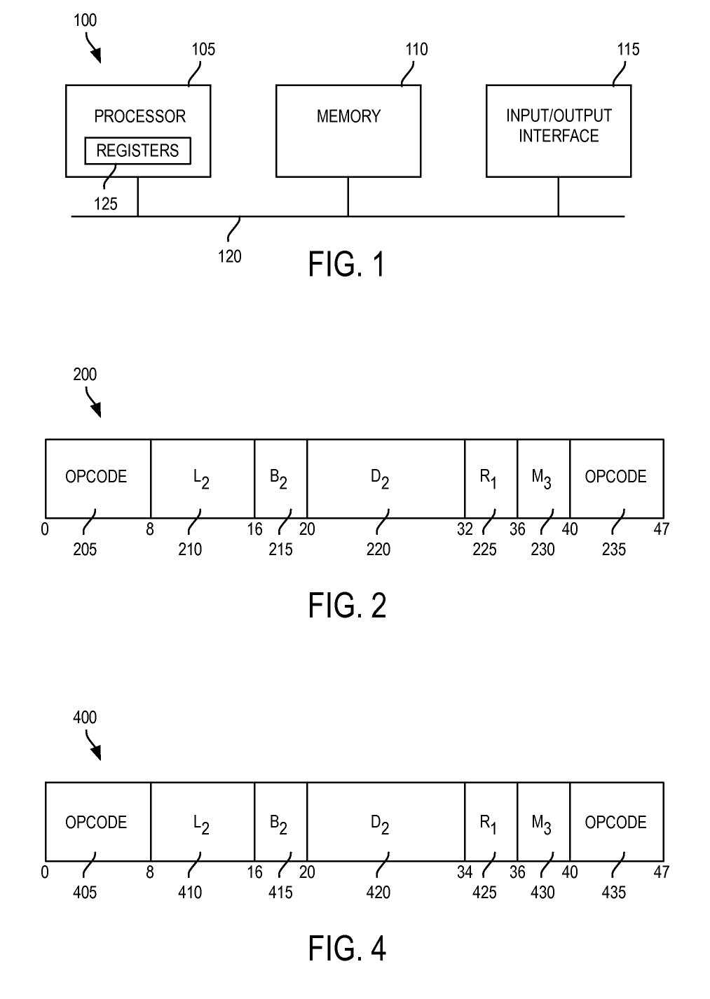

FIG. 1 illustrates a system 100 for converting data between the packed decimal format and a decimal floating point format efficiently according to some embodiments of the invention. Specifically, this figure illustrates that the system 100 includes a processor 105, a memory 110 and an input/output (I/O) interface 115, among other components (e.g., a network interface) that are not depicted for the simplicity of illustration and description. It should be understood that those other components are not necessary to an understanding of the various embodiments of the invention. The processor 105, the memory 110 and the I/O interface 115 are coupled to one another via one or more buses 120.

As known in the art, a processor or a processor family (such as 8086 and the x86-family or those of the IBM System z server family) has its own set of machine instructions. For example, the instruction set of the IBM System z server family, known as the z/Architecture instruction set, is set forth in the IBM publication z/Architecture Principles of Operation, SA22-7832-09 (10th ed. September 2012), incorporated herein by reference in its entirety. Machine instructions are patterns of bits that by design correspond to different commands to the machine. In most cases, the instruction set is specific to a class of processors using the same architecture. A machine instruction set may have all instructions of the same length, or the set may have variable-length instructions. Most instructions have one or more opcode fields which specifies the basic instruction type (such as arithmetic, logical, jump, etc.) and the actual operation (such as add or compare) and other fields that may give the type of the operand(s), the addressing mode(s), the addressing offset(s) or index, or the actual value itself. That is, each machine instruction is for performing a very specific task, such as a load, a jump, or an arithmetic logic unit (ALU) operation on a unit of data in registers or memory.

The processor 106 is a processor configured to perform machine instructions that include CDPT, CXPT, CPDT and CPXT (not shown in FIG. 1). That is, the processor 106 reads data in the packed decimal format from the memory 110, converts the data into an appropriate decimal floating point format and writes the data in the decimal floating point format to a target floating point register or a target floating point register pair of the registers 125 when performing CDPT or CXPT. The processor 106 reads data in the decimal floating point format from in a source floating point register or a floating point register pair of the registers 125, converts data in the decimal floating point format to the packed decimal format and stores the data to a target memory location in the memory 110 when performing CPDT and CPXT. The registers 125 of the processor 106 include one or more general purpose registers and/or one or more special purpose registers, including floating point registers.

The I/O interface 115 supports attachment of I/O devices to the system 100. The I/O devices that may be attached to the system 100 through the I/O interface 115 include keyboards and displays as well as disks, direct access storage devices, compact discs, and other memory media. In some embodiments, the processor 106 stores and retrieves data in the packed decimal format in a memory (not shown) that is external to the system 100 via the I/O interface 115.

FIG. 2 illustrates an example format 200 for CPDT and CPXT. The format 200 includes an opcode field 205, a length field (L₂) 210, a base register field (B₂) 215, a displacement field (D₂) 220, a register field (R₁) 225, a mask field (M₃) 230 and an opcode field 235. The opcode field 235 is an extension of the opcode field 205 to hold a longer opcode (e.g., 2-byte opcode). The numbers depicted below the format 200 are bit indexes. As shown, the format 200 of some embodiments has a length of 48 bits.

The opcode fields 205 hold an opcode (e.g., a hex value) that specifies the operation to be performed. A predefined opcode (e.g., EDAEₕₑₓ) specifies that the machine instruction represented by the format 200 is CPDT. Another predefined opcode (e.g., EDAFₕₑₓ) specifies that the machine instruction is CPXT. When the CPDT or CPXT is performed by a processor, the processor converts the second operand in the packed decimal format to a decimal floating point format. The result of this conversion is placed at the first operand location (i.e., a register or a register pair).

The length field 210 specifies the length (e.g., in bytes) of the second operand (i.e., data in the packed decimal format). In some embodiments, the length field 210 includes a length code between zero and eight (i.e., a length of one to nine bytes) for CPDT, and a length code of zero to 17 (i.e., a length of one to 18 bytes) for CPXT. That is, the number of bytes that the length field 210 indicates corresponds to the number of digits that the data in the packed decimal format have.

The base register field 215 designates a general purpose register. The contents of the general purpose register designated by the base register field 215 are added to the contents of the displacement field 220. The displacement field 220 includes contents that are added to the contents of the general purpose register designated by the base register field 215 to form the second operand address.

The register field 225 designates a floating point register. The contents of the designated register are the first operand (i.e., the data converted to the decimal floating point format). The register including the first operand is referred to as the first operand location.

The mask field 230 has four bits (e.g., bit 0 to bit 3). In some embodiments, the mask field 230 includes a sign control (e.g., bit), which in one example is bit 0 of the mask field 230. When the sign control is off (e.g., when the sign control bit is set to zero), the second operand does not have a sign digit and the sign bit of the decimal floating point first operand result is set to a value (e.g., zero) that indicates a positive sign. When the sign control is on (e.g., when the sign control bit is set to one), the second operand contains a sign digit—the rightmost four bit positions of the rightmost byte of the second operand are a sign. When the sign digit of the second operand indicates a positive value, the sign bit of the decimal floating point first operand result is set to a value (e.g., zero) that indicates a positive sign. When the sign field of the second operand indicates a negative value, the sign bit of the decimal floating point first operand result is set to a value (e.g., one) that indicates a negative sign.

In some embodiments, the mask field 230 includes an ignore-sign-digit control (e.g., bit), which in one example is bit 3 of the mask field 230. This ignore-sign-digit control is used only when the sign control is on. When the sign control is off, the ignore-sign-digit control is ignored. When the ignore-sign-digit control is off (e.g., when the ignore-sign-digit is set to zero), no action is taken. When the ignore-sign-digit control is on (e.g., when the ignore-sign-digit is set to one), the sign digit of the second operand is ignored. That is, the sign digit of the second operand is not checked for invalidity and the sign bit of the decimal floating point first operand result is set to zero, which indicates a positive sign.

When an invalid digit or sign code is detected in the second operand, or when an unused digit is not zero, a exception is recognized. If the sign control and the ignore-sign-digit control are one, no sign code checking is performed on the sign digit.

The machine instruction specified by the opcode field 205 is not performed when an exception is detected. For CDPT, the processor stops performing the machine instruction and returns an exception when the length field 210 is greater than eight. For CXPT, the processor stops performing the machine instruction and returns an exception when the length field 210 is greater than 17 or when the register field 225 designates an invalid floating point register pair.

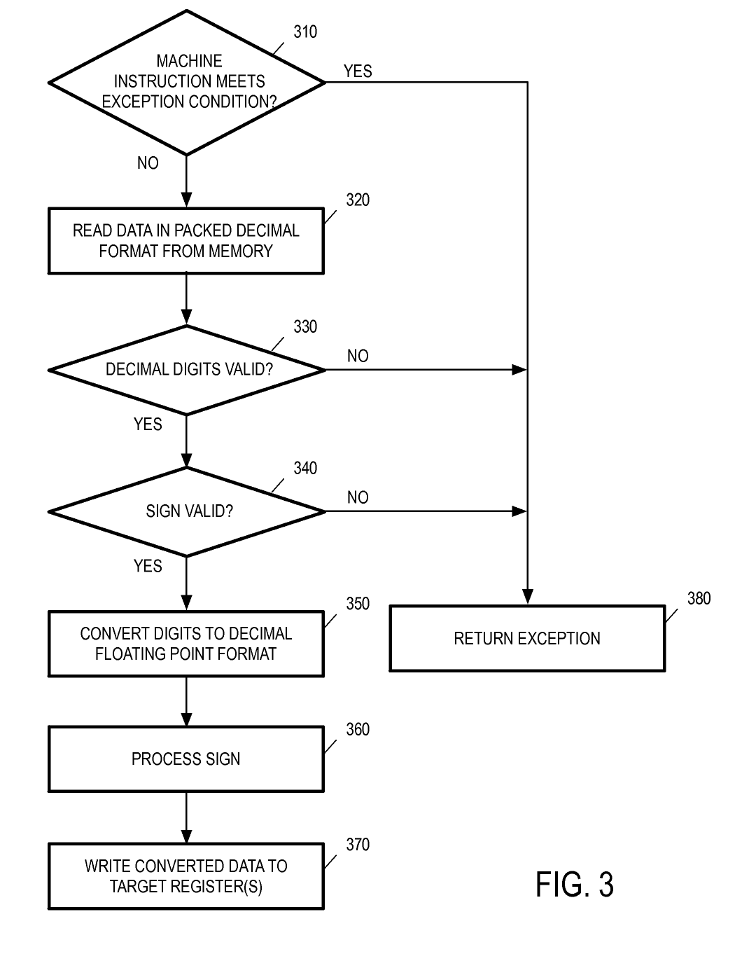

FIG. 3 depicts a process flow for executing a machine instruction in accordance with some embodiments of the invention. In some embodiments, the system 100, specifically the processor 105 of FIG. 1, performs the process flow shown in FIG. 3.

At block 310, the processor 105 verifies a received machine instruction to determine whether to return an exception and stop performing the machine instruction. Specifically, the processor 105 determines whether the received machine instruction meets any conditions for an exception. For instance, when the opcode field 205 indicates that the received machine instruction is CDPT, the processor 105 determines whether the length field 210 is greater than eight. If the length field 210 is greater than eight, the processor 105 determines that an exception condition is met. Moreover, when the opcode field 205 indicates that the received machine instruction is CPXT, the processor 105 determines whether the length field 210 is greater than 17. If the length field 210 is greater than 17, the processor 105 determines that an exception condition is met. Furthermore, when the opcode field 205 indicates that the received machine instruction is CPXT, the processor 105 also determines whether the register field 225 designates an invalid floating point register pair. If the register field 225 designates an invalid floating point register pair, the processor 105 determines that an exception condition is met.

When the processor 105 determines at block 310 that an exception condition is met, the processor 105 proceeds to block 320, which will be described further below. When the processor 105 determines at block 310 that no exception condition is met, the processor 105 at block 380 stops performing the machine instruction and returns an exception. That is, the processor 105 does not perform the operation specified by the opcode field 205 of the received machine instruction.

At block 320, the processor 105 reads data in the packed decimal format from the memory 110 as specified by the fields of the format 200. At block 330, the processor 105 checks the decimal digits in the packed decimal format for validity. If the decimal digits are invalid, the processor 105 proceeds to block 380 to stop performing the machine instruction and return an exception. At block 340, the processor 105 checks the sign in the packed decimal format for validity. If the sign is invalid, the processor 105 process to block 390 to stop performing the machine instruction and return an exception.

If the decimal digits and the sign in the packed decimal format are valid, the processor 105 proceeds to block 350 to convert the digits in the data into the decimal floating point format. Specifically, when the machine instruction is CPDT, the processor 105 converts the digits into the decimal floating point double precision format (i.e., the decimal floating point long format). When the machine instruction is CPXT, the processor 105 converts the digits into the decimal floating point extended format.

At block 360, the processor 105 sets the sign for the converted digits. Specifically, in some embodiments, the processor 105 checks the sign control bit of the format 200. When the sign control is off, the data in the packed decimal format do not have a sign field and the processor 105 sets the sign bit of the decimal floating point data to a value (e.g., zero) that indicates a positive sign. When the sign control is on, the data in the packed decimal format contains a sign digit. When this sign digit indicates a positive value, the processor 105 sets the sign bit of the data in the decimal floating point data to a value (e.g., zero) that indicates a positive sign. When the sign digit indicates a negative value, the processor 105 sets the sign bit of the data in the decimal floating point data to a value (e.g., one) that indicates a negative sign.

At block 360, the processor 105 also checks the ignore-sign-digit control when the sign control is on. That is, the processor 105 does not use the ignore-sign-digit control when the sign control is off. When the ignore-sign-digit control is off, the processor 105 takes no action. When the ignore-sign-digit control is on, the sign digit of the data in the packed decimal format is ignored. That is, the processor 105 does not check the sign digit of the data in the packed decimal format for invalidity and sets the sign bit of the data in the decimal floating point format to a value (e.g., zero) that indicates a positive sign.

At block 370, the processor 105 writes the data and the sign into the decimal floating point format register(s). Specifically, when the machine instruction is CDPT, the processor 105 writes the data in a target decimal floating point register. When the machine instruction is CXPT, the processor 105 writes the data in a pair of target decimal floating point registers of the processor 105.

Described in detail above are two instructions CDPT and CXPT that provide a means to significantly improve storage-to-storage decimal operations. The data in the packed decimal format are operated on by an arithmetic operation, such as add (AP), subtract (SP), multiply (MP) or divide (DP). These arithmetic operations must wait for the stores of a previous operation to complete before the arithmetic operations can begin, and these arithmetic operations then store the results to memory. The memory dependencies from the operations dominate the performance. Other operations such as compare, shift, and sign manipulation may also be performed as register-based operations instead of storage-to-storage operations and thereby increasing the performance.

Employing the new instructions CDPT and CXPT (e.g., recompiling the source code of a program with CDPT and CXPT enabled) replaces the arithmetic operations for the packed decimal format with the decimal floating point format equivalent (e.g., AD/XTR, SD/XTR, MD/XTR, DT/XTR) such that there is no wait for any operands (i.e., data) to be stored or read from memory. AD/XTR, SD/XTR, MD/XTR and DT/XTR operate in a similar amount of time as AP, SP, MP or DP, but without the memory overhead.

CDPT and CXPT instructions provide an efficient means for converting data from the packed decimal format in memory directly into the decimal floating point formats in register. CDPT and CXPT allow the data to be converted from the packed decimal format to the decimal floating point format in a single step. Conventionally, the data in the packed decimal format must be loaded into general purpose registers, but since there is no length-controlled load currently in the conventional instruction set architecture, this often requires a mix of word, half-word and byte-load operations. Other machine instructions can then be used to convert data in the packed decimal format in the general purpose register/general purpose register-pair to the target decimal floating point format. In contrast, CDPT or CXPT allows the data to be converted from the packed decimal format in memory to the decimal floating point format in target register(s) in a single step.

In some cases, data in the packed decimal format stored on disk or tape cannot have a trusted sign. Therefore, a conventional compiler that is not enabled for using CDPT and CXPT instructions inserts an OR IMMEDIATE (0I) instruction for each operand to force the sign digit to be Fₕₑₓ. This additional cleanup of the input operands introduces extra memory latency. In contrast, employing CDPT and CXPT enables removing these OI instructions by instead setting the ignore-sign-digit bit to force a positive value to be generated as part of the format conversion from the packed decimal format to the decimal floating point format.

In addition to Convert from Packed to decimal floating point instructions (CDPT and CXPT), CPDT and CPXT instructions are provided. CPDT and CPXT provide an efficient means of converting data from the decimal floating point format held in a floating point register or floating point register pair to the packed decimal format and storing the converted data directly to memory.

FIG. 4 illustrates an example format 400 for CPDT and CPXT. The format 400 includes an opcode field 405, a length field (L₂) 410, a base register field (B₂) 415, a displacement field (D₂) 420, a register field (R₁) 425 a mask field (M₃) 430 and an opcode field 435. The numbers depicted below the format 400 are bit indexes. As shown, the format 400 of some embodiments has a length of 48 bits.

The opcode field 405 holds an opcode (e.g., a hex value) that specifies the operation to be performed. A predefined opcode (e.g., EDACₕₑₓ) specifies that the machine instruction represented by the format 400 is CPDT. Another predefined opcode (e.g., EDADₕₑₓ) specifies that the machine instruction is CPXT. When the CPDT or CPXT is performed by a processor, the processor converts the significand digits of the first operand (i.e., data in the decimal floating point format) and the sign bit of the first operand to the packed decimal format. The processor ignores the exponent in the combination field and treats as if the exponent had a value of zero, before biasing.

The length field 410 specifies the number of bytes containing rightmost significand digits of the first operand. In some embodiments, the length field 410 includes a length code between zero and eight (i.e., a length of one to nine bytes) for CPDT, and a length code of zero to 17 (i.e., a length of one to 18 bytes) for CPXT. The number of bytes that the length field 410 indicates also corresponds to the number of digits that the data converted to the packed decimal format is to have. When the CPDT or CPXT is performed by a processor, the processor places the number of bytes indicated by the length field 410 at the second operand location. If there are not enough significand digits to fill all of the bytes of the data converted into the packed decimal format, the processor appends zero digits to the significand as leftmost digits.

The base register field 415 designates a general purpose register. The contents of the general purpose register designated by the base register field 415 are added to the contents of the displacement field 420. The displacement field 420 includes contents that are added to the contents of the general purpose register designated by the base register field 415 to form the second operand address.

The register field 425 designates a register. The contents of the designated register are the first operand (i.e., the source data in the decimal floating point format). The register including the first operand is referred to as the first operand location.

The mask field 430 has four bits (e.g., bit 0 to bit 3). In some embodiments, the mask field 430 includes a sign control (e.g., bit), which in one example is bit 0 of the mask field 430. When the sign control is on (e.g., when the sign control bit is set to one), the second operand is to have a sign digit—the rightmost four bit positions of the rightmost byte of the second operand is to have a sign. When the sign control is off (e.g., when the sign control bit is set to zero), the second operand is not to have a sign digit.

In some embodiments, the mask field 430 includes a plus-sign-code control (e.g., bit), which in one example is bit 2 of the mask field 430. This plus-sign-code control is used only when the sign control is on. When the sign control is off, the plus-sign-code control is ignored. When the plus-sign-code control is off (e.g., when the plus-sign-code control is set to zero), the plus sign is encoded as a value (e.g., 1100₂ or Cₕₑₓ) that indicates a positive sign. When the plus-sign-code control is on (e.g., when the plus-sign-code control is set to one), the plus sign is encoded as a value (e.g., 1111₂ or Fₕₑₓ) that indicates an unsigned number.

In some embodiments, the mask field 430 includes a force-plus-zero control (e.g., bit), which in one example is bit 3 of the mask field 430. This force-plus-zero control is used only when the sign control is on. When the sign control is off, the force-plus-zero control is ignored. When the force-plus-zero control is off (e.g., when the force-plus-zero control is set to zero) and a signed value of a negative zero results, no action is taken. When the force-plus-zero control is on (e.g., when the force-plus-zero control is set to one) and the absolute value of the conversion result to be placed in the second operand location is zero, the sign digit of the conversion result is set to indicate a positive zero with a sign code specified by the plus-sign-code control.

CPDT or CPXT is performed for any type of the first operand, including an infinity, QNaN, or SNaN, without causing an exception. If the first operand is special (i.e., infinity, QNaN or SNaN), a zero digit is appended as the leftmost digit of the significand, thereby conceptually forming the effective significand to be converted. The specified number of rightmost effective significand digits and the sign bit are converted to the packed decimal format. The conversion result is placed at the second operand location, and the execution of CPDT or CPXT completes with an appropriate condition code. The example condition codes include zero for indicating that the source data is zero in the decimal floating point format; one for indicating that the source data is not special and is less than zero; two for indicating the source data is not special and is greater than zero; and three for source is special—infinity, QNaN, SNaN, or a partial result.

For any type of the first operand, including an infinity and a NaN, when one or more leftmost nonzero digits of the significand are lost because the second operand field is too short, the conversion result is obtained by ignoring the overflow digits. Then, condition code three is set. If the decimal overflow mask bit is one, a program interruption for decimal overflow occurs. The operand lengths alone are not an indication of overflow; non-zero digits must have been lost during the operation.

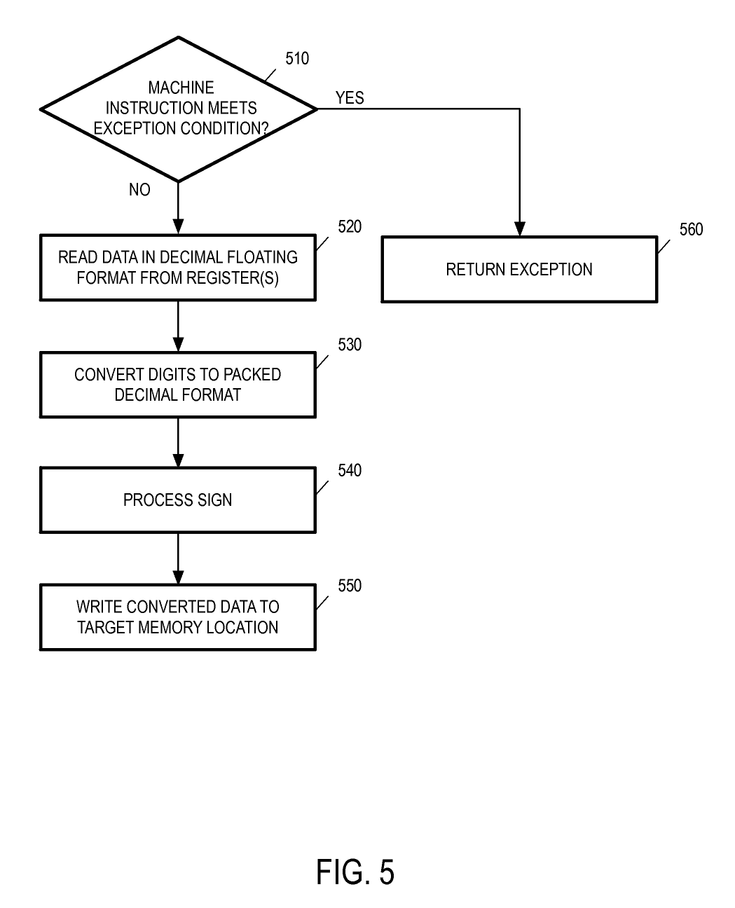

FIG. 5 depicts a process flow for executing a machine instruction in accordance with some embodiments of the invention. In some embodiments, the system 100, specifically the processor 105 of FIG. 1, performs the process flow shown in FIG. 5.

At block 510, the processor 105 verifies a received machine instruction to determine whether to return an exception and stop performing the machine instruction. Specifically, the processor 105 determines whether the received machine instruction meets any conditions for an exception. For instance, when the opcode field 405 indicates that the received machine instruction is CPDT, the processor 105 determines whether the length field 410 is greater than eight. If the length field 410 is greater than eight, the processor 105 determines that an exception condition is met. Moreover, when the opcode field 405 indicates that the received machine instruction is CPXT, the processor 105 determines whether the length field 410 is greater than 17. If the length field 410 is greater than 17, the processor 105 determines that an exception condition is met.

When the processor 105 determines at block 510 that an exception condition is met, the processor 105 proceeds to block 520, which will be described further below. When the processor 105 determines at block 510 that no exception condition is met, the processor 105 at block 560 stops performing the machine instruction and returns an exception. That is, the processor 105 does not perform the operation specified by the opcode field 405 of the received machine instruction.

At block 520, the processor 105 reads data in the decimal floating point format from a decimal floating point register or a decimal floating point register pair as specified by the fields of the format 400. At block 530, the processor 105 converts the digits in the data in the decimal floating point format into the packed decimal format. Specifically, if the data in the decimal floating point format is special (i.e., infinity, QNaN or SNaN), the processor 105 appends a zero digit as the leftmost digit of the significand. The processor 105 also converts the specified number of rightmost effective significand digits and the sign bit to the packed decimal format.

At block 540, the processor 105 sets the sign for the converted digits. Specifically, in some embodiments, the processor 105 checks the sign control bit of the format 400. When the sign control is on, the processor 105 sets a sign digit for the converted data in the packed decimal format. The processor 105 sets a sign in the rightmost four bit positions of the rightmost byte of the data in the packed decimal format. When the sign control is off, the processor 105 does not set a sign digit for the converted data in the packed decimal format.

At block 540, the processor 105 also checks the plus-sign-code control when the sign control is on. That is, the processor 105 ignores the plus-sign-code control when the sign control is off. When the plus-sign-code control is off (e.g., when the plus-sign-code control is set to zero), the processor 105 encodes the plus sign as a value (e.g., 1100₂ or Cₕₑₓ) that indicates a positive sign. When the plus-sign-code control is on (e.g., when the plus-sign-code control is set to on), the processor 105 encodes the plus sign as a value (e.g., 1111₂ or Fₕₑₓ) that indicates an unsigned number.

Also at block 540, the processor 105 checks the force-plus-zero control when the sign control is on. The processor 105 ignores the force-plus-zero control when the sign control is off. When the force-plus-zero control is off and a signed value of a negative zero results, the processor 105 takes no action. When the force-plus-zero control is on and the absolute value of the data converted to the packed decimal format is zero, the processor 105 sets the sign digit of the data to indicate a positive zero with a sign code specified by the plus-sign-code control.

At block 550, the processor 105 writes the data in the packed decimal format to the target memory location. In some embodiments, the processor 105 also returns an appropriate condition code.

CPDT and CPXT instructions provide an efficient means for converting data from the decimal floating point format held in a floating point register or a floating point register pair to the packed decimal format and storing the converted data to memory directly. Conventionally, the data in the decimal floating point format must be converted the packed decimal format in general purpose registers. Then the data converted to the packed decimal format must be stored out of general purpose registers to memory, but since there is no length-controlled load currently in the conventional instruction set architecture, this often requires a mix of word, half-word and byte-load operations. In contrast, CDZT or CXZT allows the data to be converted from the decimal floating point format in register(s) to the packed decimal format in memory in a single step. Thus, the functioning of a computer itself may be improved.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of converting data from one format to another format by executing a machine instruction, the method comprising:
reading data in a packed decimal format from a memory that is communicatively coupled to a processor;
converting, by the processor, the data in the packed decimal format into a decimal floating point format; and
writing the data converted into the decimal floating point format to one or more target registers of the processor.

2. The method of claim 1, wherein the converting comprises:
ignoring a sign digit of the data in the packed decimal format; and
forcing a positive sign for the data converted into the decimal floating point format.

3. The method of claim 1, wherein the one or more target registers are special purpose registers different from general purpose registers.

4. The method of claim 3, wherein the machine instruction is executed without writing the data in the packed decimal format to any general purpose register after reading it from the memory.

5. The method of claim 1, wherein the reading, converting and writing are performed according to the machine instruction.

6. The method of claim 5,
wherein the machine instruction comprises an opcode field to provide an opcode, the opcode specifying that a convert from the packed decimal format to the decimal floating point format is a task to perform,
wherein the machine instruction is for converting data in the packed decimal format to a decimal floating point double precision format if the opcode is a first value,
wherein the machine instruction is for converting data in the packed decimal format to a decimal floating point extended format if the opcode is a second value.

7. The method of claim 5, wherein the machine instruction comprises a control bit, wherein the converting comprises, when the control bit is set to a value that indicates the control is on:
ignoring a sign digit of the data in the packed decimal format; and
forcing a positive sign for the data converted into the decimal floating point format.
